(19) United States
(12) Patent Application Publication
(10) Pub. No.: US 2010/0300591 A1
(43) Pub. Date: Dec. 2, 2010

(54) Self-inflating wheel

(76) Inventor: Richard M. Rheinhardt, Lady Lake, FL (US)

Correspondence Address: Rheinhardt of Evansville, Inc., 415 County Road, Pocasset, MA, 02559, US

(21) Appl. No.: 12/070,807

(22) Filed: Feb. 21, 2008

(51) Int. Cl. B60C 29/02

(52) U.S. Cl. 152/427

(57) ABSTRACT

A self-inflating wheel having a rim for mounting a tire to form an airtight chamber for retaining air at a predetermined first level of pressure, a reservoir for retaining air at a second level of pressure higher than the first level, a valve for feeding air into the reservoir from an external source and a valve connecting the reservoir and the chamber for feeding air to the chamber in response to the pressure therein being lower than the first level.

### BACKGROUND OF THE INVENTION

1. Field of the Invention

The invention, in general, relates to a vehicular wheel of the kind consisting of a substantially rigid rim and a resilient tubeless tire mounted thereon and, more particularly, to a wheel of the kind referred to which is capable of maintaining a substantially constant level of pressure within its tire.

2. The Prior Art.

One of the hazards and annoyances of driving a motor vehicle involves the loss of air pressure from any of its tires. The most common cause for tire pressure loss is a natural one and results from diffusion through the walls of a tire. Such diffusion may cause a loss of tire pressure of about 1 psi per month, and while it is recommended that such loss be replenished at monthly intervals, it seldom is. Other slow leaks, as may occur, for instance, as a result of a sharp object embedded in a tire, of a puncture, of a faulty fit between a flange of the rim and the bead of the tire or of a defective valve, may be more readily noticeable and, therefore, attended to. Yet any slow tire leak leads to potentially hazardous driving conditions. Underinflated tires result in unreliable braking, increased tire wear, increased fuel consumption and increased levels of hazardous engine emissions. It may even lead to irreparable damage to at least the affected tire if, for instance, the pressure of the tire were to drop below a certain level, as the rim flanges would then roll along, and cut through, the outwardly spread side walls of the tire. In the case of radial tires, this may well require the replacement of the entire set of tires at considerable expense. Pointed objects such as, for instance, nails, or rim flanges deformed by impact with potholes or side curbs not infrequently are the cause of such slow leakages. They often go unnoticed for many hours, especially while the vehicle is driven. Sometimes they are detected accidentally, either by a visually apparent lower tire profile or, rather more precariously, by irregular steering and braking action.

Tire pressure sensors have become known and, indeed, are mandated for late model automotive vehicles, for sensing deviations from desired levels of air pressure within tire air chambers and for releasing signals perceivable by the operator of the vehicle to induce him to take corrective action. Such corrective action may be an exchange of the defective wheel for a properly inflated one or, circumstances permitting, replenishment of the tire pressure from an external source or, in case of a puncture, of having the tire repaired.

Applicant's U.S. Pat. No. 6,601,625 B2 issued 5 Aug. 2003 discloses an arrangement of a rim with a tire mounted thereon which is intended to address and substantially reduce the problem of underinflated tires by the provision of a reservoir having a chamber for storing air at a high level of pressure in excess of the pressure in the tire chamber. The high level air pressure is filled into the reservoir from an external source by way of a first valve. A second valve connects the reservoir chamber to the tire chamber to allow air to flow from the reservoir chamber to the tire chamber to restore its pressure whenever it drops below a predetermined level. It will be understood by those skilled in the art that the flow of pressure restorative air from the reservoir chamber into the tire chamber can continue only until the pressure in both chambers is substantially equal. After this equilibrium has been reached both chambers will lose air.

The reservoir chamber and the tire chamber are each provided with a relief valve to prevent excessive pressure build-up by venting air to the atmosphere.

Though in general the arrangement disclosed by the said U.S. patent functions satisfactorily, yet has it in some circumstances been found to be less reliable than is deemed desirable. One of the problems encountered was that pressure increases in the reservoir chamber as well as in the tire chamber in consequence of increased ambient temperatures resulted in venting of air from both chambers and subsequently, when ambient temperatures dropped again, in reduced air pressure in both chambers. While the resultant sub-normal pressure in the tire chamber could be restored by air from the reservoir chamber, the lower pressure in the reservoir chamber resulted in undesirably fewer tire pressure restoring cycles. The problem was aggravated by repeated air venting cycles.

### OBJECTS OF THE INVENTION

It is, therefore, a primary object of the invention to provide a wheel and tire arrangement of the kind referred to which is of improved reliability.

Another object of the invention is to provide a wheel and tire arrangement of the kind referred to which is of increased efficiency.

Still another object of the invention is to provide an arrangement of the kind which is of simplified structure.

Yet another object of the invention is to provide an arrangement of the kind referred to which does not vent air from either the reservoir chamber or the tire chamber in response to elevated ambient temperatures.

Other objects will in part be obvious and will in part appear hereinafter.

### BRIEF SUMMARY OF THE INVENTION

In the accomplishment of these and other objects, the invention provides for a wheel consisting of a flanged rim, a tubeless tire mounted thereon to form a substantially annular chamber between them for retaining air at a first level of pressure, a reservoir forming a chamber capable of retaining air at a second level of pressure substantially higher than the first level and a first valve connecting the reservoir chamber to the annular chamber in response to a drop in the first level of pressure for restoring the first level of pressure by feeding air from the reservoir chamber. The reservoir may be mounted relative to the wheel in any suitable disposition but is preferably of annular structure concentrically mounted on the wheel. In a particularly advantageous disposition the reservoir may be mounted on the rim intermediate its bead-engaging flanges and internally of the tire. The reservoir chamber is provided with a second valve adapted to feed pressurized air from an external source air to raise pressure to the first level in the reservoir chamber and, by way of the first valve, to the second level in the annular chamber. The first valve may be a conventional pressure regulating valve and may be manually adjustable or preset to close in response to the second level of pressure having been reached in the annular chamber. The second valve may be a conventional one-way valve of the Schrader® or Presta® type. Furthermore, to facilitate tire repairs at least the annular chamber may be provided with a removable plug for venting air.

### DESCRIPTION OF THE SEVERAL DRAWINGS

The novel features which are considered to be characteristic of the invention are set forth with particularity in the appended claims. The invention itself, however, in respect of its structure, construction and lay-out, as well as manufacturing techniques, together with other objects and advantages thereof, will be best understood from the following description when read with reference to the drawings, in which:—

FIG. 1 is a cross-sectional view of a self-inflating vehicular wheel in accordance with the invention schematically showing the rim, the reservoir and the tire; and

FIG. 2 is a side elevation, partially in axial section, of the wheel of FIG. 1.

### DETAILED DESCRIPTION OF THE PREFERRED EMBODIMENTS

While pressurized air is the conventional medium for inflating tires, it will be understood by those skilled in the art that the invention is not so limited. For purposes of the instant invention, any reference herein to air is intended to connote and include any other gaseous medium and change of state gas.

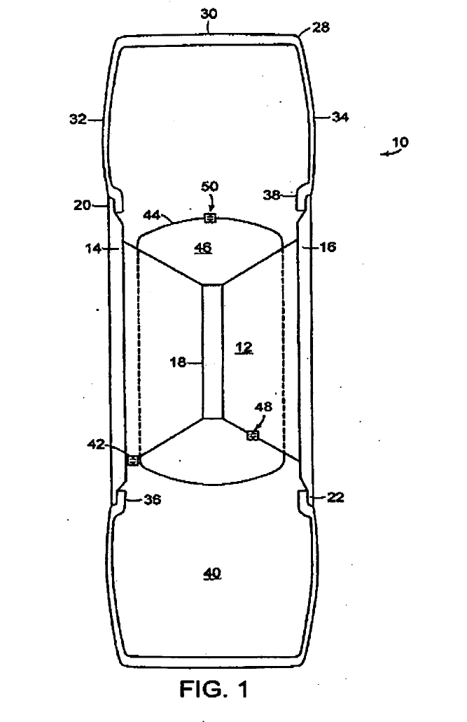

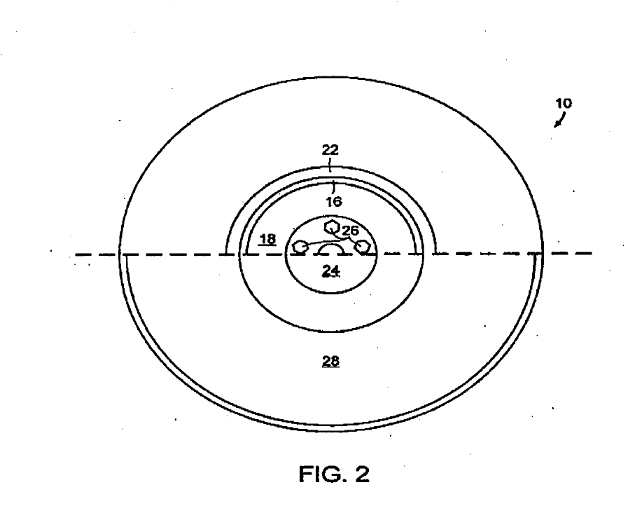

As schematically shown in FIG. 1, the wheel 10 consists of a substantially rigid rim 12 made of any conventional material such as, for instance, steel, carbon-reinforced polymer, magnesium or aluminum alloy and having first and second flanges 14, 16 coaxially mounted on opposite ends of an annular hub 18. The flanges 14 and 16 are provided with annular lips 20, 22. The hub 18 is also provided with a concentric wheel mounting surface 24 with a plurality of circularly evenly spaced and concentrically arranged openings (not shown) for receiving wheel mounting bolts or studs 26, three of which are shown in FIG. 2. While the rim 12 as shown has a zero or neutral offset, it will be appreciated by those skilled in the art that the present invention is equally applicable to wheels of the more common negative or positive offset regardless of their shape or the shape of their hub. It will be appreciated by those skilled in the art that the configuration of the rim and hub schematically shown here may in fact be rather different without affecting the instant invention.

A tubeless tire 28 of resilient material and having a tread surface 30, sidewalls 32, 34 and beads 36, 38 is mounted in a conventional manner on the rim 12 with the beads 36, 38 forming seals with the lips 20 and 22, respectively. Together, the tire 28 which may have an inner lining of impervious halobutyl and the rim 12 form an enclosed annular tire chamber 40. To allow selective evacuation of pressure, the tire chamber 40 is, however, provided with a schematically shown plug 42 threadedly seated within a threaded bore (not shown) in the hub 18. If desired, the plug 42 may be replaced by a suitable valve.

By way of example and without intent to limit its configuration or disposition, there is provided within the tire chamber 40, and concentrically mounted in radially and circumferentially immovable engagement with the hub 18, a high pressure reservoir 44 forming a reservoir chamber 46. The reservoir 44 is made of a high tensile material impervious to gas, such as, for instance, fiber-reinforced rubber or metal and alternatively may, depending upon the material from which it is made, either be retrofitted on, or formed integrally with, the rim 12. It will be understood by skilled artisans that neither shape nor disposition of the reservoir 44 are significant in terms of the inventive concept. However, a reservoir 44 mounted on the wheel 10 in a balanced manner to prevent irregular movements is currently preferred. In the event, the material from which the reservoir 44 is made must be such as to withstand, substantially without deformation, pressure several times greater than the pressure in the tire chamber 40. It will be understood by skilled artisans that disposition and configuration of the reservoir 44 will be such as not to interfere with any movement of the wheel 10.

The reservoir 44 is provided with a schematically shown first valve 48 extending to the exterior through a conventional valve hole (not shown) in the hub 18. The valve 48 may, for instance, be a conventional Schrader® valve for one-way flow of air under pressure from the exterior into the reservoir chamber 46. Other valves, such as, Presta® valves or any other one-way flow valves, including, preferably, valves limiting the level of pressure in the reservoir chamber 46, would be equally suitable and are well-known in the art.

A schematically shown second valve 50 is provided for selectively connecting the reservoir chamber 46 with the tire chamber 40. The second valve 50 is preferably a pressure regulating valve of any of the well-known types and serves not only for initially feeding air from the reservoir chamber 46 to the tire chamber 40 up to a level preset or manually adjusted at the valve 50 but also for subsequently maintaining or restoring the set level of pressure within the tire chamber 40 whenever its set pressure is reduced as, for instance, by a slow leak. That is to say that the valve 50 is preset or calibrated to open automatically when the pressure in the tire chamber 40 is below its predetermined level and to close when the pressure level has attained its preset level again. To avoid jagged opening and closing, the valve 50 may be adjusted respectively to open and close at predetermined pressure levels slightly below and slightly above the “normal” pressure in the tire chamber 40. As long as air pressure within the reservoir chamber 46 is higher than the normal pressure set for the tire chamber 40, the valve 50 opens automatically in response to pressure in the tire chamber 40 being reduced below the normal level in order to restore that level. Such valves are well-known in the art and are thought not to require a detailed description. Once the pressure in the reservoir chamber 46 has been exhausted to a level equal to the pressure set for the tire chamber 40, the valve 50 closes to maintain pressure in the reservoir chamber 46 at the level set for the tire chamber 40. While such a state would result in further depletion of the pressure in the tire chamber 40, the concept underlying the instant invention is that before the occurrence of such a condition, the slow leak in the tire 28 will have been stopped or the pressure in the reservoir chamber 46 will have been replenished.

While the reservoir 44 has been depicted as circumscribing the hub 18 of the rim 12, other configurations and dispositions are possible as well. For instance, the reservoir may be structured as a disc or toroid mounted coaxially with the wheel, or it may occupied or constituted by any hollow spaces in spokes of the wheel 10. None of such structures are intended as limitations of the possibilities. The changes in the positions of the first and second valves required by the various possible shapes of the reservoir are believed to be obvious to one skilled in the art and are deemed not to require a detailed description.

Assembly and function of the self-inflating vehicular wheel 10 in accordance with the invention are substantially as follows:

If the rim 12 is not provided with an integral reservoir 44, a reservoir 44 of suitably elastic material may, for instance, be mounted on the hub 18 as shown in FIG. 1 by being pulled over one of the flanges 14, 16 before a tire 28 is mounted on the rim 12. Preferably, the reservoir 44 is positioned so as to align its valve 48 with a valve hole in the flange or hub, as the case may be. A suitably shaped further hole may thereafter be formed in the hub 18 for seating an air evacuation plug 42 in an airtight manner. If the rim 12 is provided with an integral reservoir 44 there will, of course, be no need for aligning the valve 48 or for forming a hole for an evacuation plug.

If the pressure level of the valve 50 is not preset, the level of air pressure appropriate for the tire to be mounted is then calibrated or set on the second valve 50 prior to mounting of the tire 28 on the rim 12 in the conventional manner. Thereafter, the first valve 48 will be connected to an external source (not shown) of pressurized air and air will initially flow into the reservoir chamber 46 and into the tire chamber 40 until pressure therein has reached its preset level, e.g. 32 psi. The valve 50 then closes; but air continues to flow into the reservoir chamber 46 until the pressure therein has also reached its predetermined level, e.g. 160 psi, which is a multiple of the pressure level in the tire chamber 40 to ensure safe and reliable operation of the arrangement in accordance with the invention over a period considerably longer than in an arrangement without a back-up reservoir of the kind here disclosed.

Before being mounted on a vehicle, the wheel 10 may be balanced in a manner well-known in the art. In this connection, weights and positions of the first and second valves 44, 50 as well as of the evacuation plug or valve 42 would advantageously be such as to keep any counterweights conventionally used for wheel balancing at a minimum.

It will be understood by persons skilled in the art that frictionally generated heat will cause a slight increase in air pressure in the reservoir chamber 46 and in the tire chamber 40 when the vehicle is moving and that the pressure will revert to normal after the vehicle has stopped. Such changes may be ignored by appropriately setting of the valve 50.

It is within the ambit of the present invention to provide appropriate sensors in the reservoir chamber 46 and in the tire chamber 40 as well as in connection with the second valve 50 and to connect them to a monitor or warning device for the purpose of alerting a vehicle operator of potential tire problems.

What is claimed is:

1. A self-inflating wheel, comprising:
a rim;
a tire adapted to be mounted on the rim to form an enclosed tire chamber therewith for retaining air at a first level of pressure;
a reservoir forming a reservoir chamber for retaining air at a second level of pressure higher than the first level;
a first valve connected with the reservoir chamber for feeding air thereinto from an external source up to the second level of pressure; and
a second valve responding to air pressure in the tire chamber being lower than the first level for feeding air from the reservoir chamber to the tire chamber to restore the pressure therein substantially to the first level.

2. The self-inflating wheel of claim 1, wherein the first valve is a Schrader® valve.

3. The self-inflating wheel of claim 1, wherein the first valve is a Presta® valve.

4. The self-inflating wheel of claim 1, wherein the first valve is of the kind which closes when the second level of pressure has been reached.

5. The self-inflating wheel of claim 1, wherein the second valve is a pressure regulating valve.

6. The self-inflating wheel of claim 5, wherein the second valve is of kind which closes when the first level of pressure has been reached in the tire chamber.

7. The self-inflating wheel of claim 5, wherein the first level of pressure is preset on the valve.

8. The self-inflating wheel of claim 1, wherein the reservoir is mounted concentrically on the rim.

9. The self-inflating wheel of claim 8, wherein the rim comprises two parallel flanges and the reservoir is mounted between the flanges.

10. The self-inflating wheel of claim 9, wherein the reservoir is positioned within the tire chamber.

11. The self-inflating wheel of claim 8, wherein the reservoir is removably mounted on the rim.

12. The self-inflating wheel of claim 10, wherein the reservoir is formed integrally with the rim.

13. The self-inflating wheel of claim 1, further comprising means for selectively exhausting air from the tire chamber.
